(19) United States
(12) Patent Application Publication
(10) Pub. No.: US 2002/0155302 A1
(43) Pub. Date: Oct. 24, 2002

(54) Method for preparing laminated safety glass

(76) Inventors: Novis W. Smith, Philadelphia, PA (US); Nelson Bolton, Trumbauersville, PA (US)

Correspondence Address: John Lezdey, 1409 N Ft. Harrison, Suite A, Clearwater, FL, 33755, US

(21) Appl. No.: 09/837,960

(22) Filed: Apr. 19, 2001

(51) Int. Cl. B32B 17/10

(52) U.S. Cl. 428/442; 428/163; 428/441; 156/106; 156/104; 156/105

(57) ABSTRACT

A method for preparing a transparent laminated article comprising a bonding layer which is an extruded copolymer having contiguous grooved or scored surface and a transparent sheet of glass laminated to at lest one surface of the layer which comprises the steps of:

A. providing a multiplicity of contiguous grooves on at least one surface of a bonding layer;

B. placing the surface of said glass sheet in contact with a grooved or scored surface of said bonding layer and then;

C. applying heat and pressure or vacuum to the bonding layer and glass sheet(s) to form a laminate.

### FIELD OF THE INVENTION

The present invention relates to a method for preparing laminated safety glass structures having good optical clarity. More particularly, the invention relates to the manufacture of laminated safety glass structures having a plurality of glass layers which have good optical clarity and are resistant to delamination. The safety glass structures may be used for aircraft, land vehicles, as armor structures for security installations, and the like.

### BACKGROUND OF THE INVENTION

Energy absorbing laminates for use as safety glass is well known. Customarily, these products are formed from transparent materials of different compositions and are composed of an outer layer of one or more plies and an inner layer, which is bonded together with the outer layer by a resinous interlayer. Usually, a relatively thick glass outer layer is combined with at least one relatively thin inner layer.

Laminated safety glass must satisfy certain quality requirements according to the purpose for which it is to be used. In the case of motor vehicles, these quality requirements as laid down in the “Strassenverkehrszulassungsordnung” of the German Federal Republic, Section 22, No. 29, in “Motor Vehicle Safety Standards” Nos. 205 and 208, and in U.S.A. Standard Z 26.1-1966. Quality requirements for use in the building industry are established in “American national Standard Institute” Standard Z 97.1-1966, for use as bulletproof material they are specified in “Underwriters Laboratories” Standard 752.

In the specification and claims the terms an “extrudable polymer” comprising neutralized or partially neutralized ethylene or alpha olefin-carboxylic acid copolymers and mixtures thereof of interest are the copolymers prepared from a combination of ethylene or propylene monomers and acrylic acid and methacrylic acid. Furthermore, of particular significance are the sodium or potassium neutralized ethylene or alpha olefin-carboxylic acid copolymers, i.e. methacrylic or acrylic acid, copolymers. Properties which distinguish the copolymers from other polyolefin heat-seal polymers are their high clarity, melt strength, solid-state toughness and resistance to oil/fat permeation. The extruded copolymers are generally commercially available as either a sodium or a potassium ionomer, and are available in a wide variety of grades from AGP, Inc, of Traumbersville, Pa. Amine salts of the copolymers are also included, as are the acid form, partially neutralized acid form, and metal salts of the acid copolymers.

The terms “knurled or embossed surface” as used herein include any form of contiguous raised or grooved surface including those prepared with crimping, embossing and knurling apparatus.

### SUMMARY OF THE INVENTION

According to the present invention, there is provided a novel process for preparing an optically transparent laminate composed of at least one bonding layer and at least one glass sheet. The process comprises the steps of:

A. providing a multiplicity of contiguous grooves or scores on at least one surface of a bonding film or stack of films, said bonding film being an extruded composition containing 0 to 5% by weight of a diamine;

B. placing a glass sheet in contact with the grooved surface of the bonding layer, and then;

C. applying sufficient heat and pressure to the combination to form a laminate.

It has been found that when the bonding film is contiguously grooved, gases and bubbles, which commonly form between the layers when the assembly is heated, are easily removed. The grooved or scored surface disappears as the temperature rises and pressure is applied.

Advantageously, the bonding layer comprises an extruded composition comprising a polyolefin and from 13 to 21% by weight of methacrylic or acrylic acid monomers which have been neutralized from 40 to 90% with an alkali metal cation and which have a Tg of less than 210° F.

Preferably, the assembly is placed prior to heating in a sealed container or a bag of the type disclosed in U.S. Pat. No. 3,311,517, which is herein incorporated by reference.

The assembly may be heated in an oven and then passed through nip rollers to accomplish the lamination. This can then be followed by autoclave treatment without bagging.

The assembly is treated in a conventional manner such as disclosed in U.S. Pat. No. 4,668,574. That is, the assembly is heated to a temperature about 255-280° F. and under a pressure of about 20 to 200 psi. Advantageously, after the heat treatment under pressure the assembly is cooled to a temperature of about 150° F. within a period of about 30 to 45 minutes to prevent clouding.

The method of the invention can be used to form laminates having a single glass sheet, a bonding layer sandwiched between a first glass sheet and optionally a second glass sheet or multi-layered laminates as described in U.S. Pat. No. 4,619,973, which is herein incorporated by reference.

It is an object of the invention to provide a process for preparing a laminate which is free of bubbles and possesses high optical clarity.

Other objects and a fuller understanding of the invention will be had by referring to the following description and claims of a preferred embodiment, taken in conjunction with the accompanying drawings, wherein like reference characters refer to similar parts throughout the several views.

### BRIEF DESCRIPTION OF THE DRAWINGS

FIGS. 1 and 1A are perspective views of an ionomer having a contiguous grooved surface for use in the process of the invention;

FIG. 2 is an exploded view showing a grooved bonding film between a pair of glass sheets.

FIG. 3 is a front view partially in cross-section showing the laminate of FIG. 2, after being subjected to heat and compression;

FIG. 4 is a front view of a laminate formed by the process of the invention with a hard coat, and

FIG. 5 is a fragmentary of a bonding with non-contiguous grooves.

### DESCRIPTION OF THE PREFERRED EMBODIMENTS OF THE INVENTION

Although specific terms are used in the following description for the sake of clarity, these terms are intended to refer only to the particular structure of the invention selected for illustration in the drawings, and are not intended to define or limit the scope of the invention.

It is understood that the following description omits many structural elements commonly found in laminating glazing units for aircraft, such as mounting frames, such as those in U.S. Pat. No. 3,081,205 to Shorr, electrical terminal blocks and special insulators for lead lines connecting bus bars for the defogging or deicing device of U.S. Pat. No. 3,410,739 to Orcutt, temperature sensing deices, such as those shown in U.S. Pat. No. 3,789,191 to Spindler, reinforcing frames such as those shown in the aforesaid Orcutt and Shorr patents and other structural elements well known in the art.

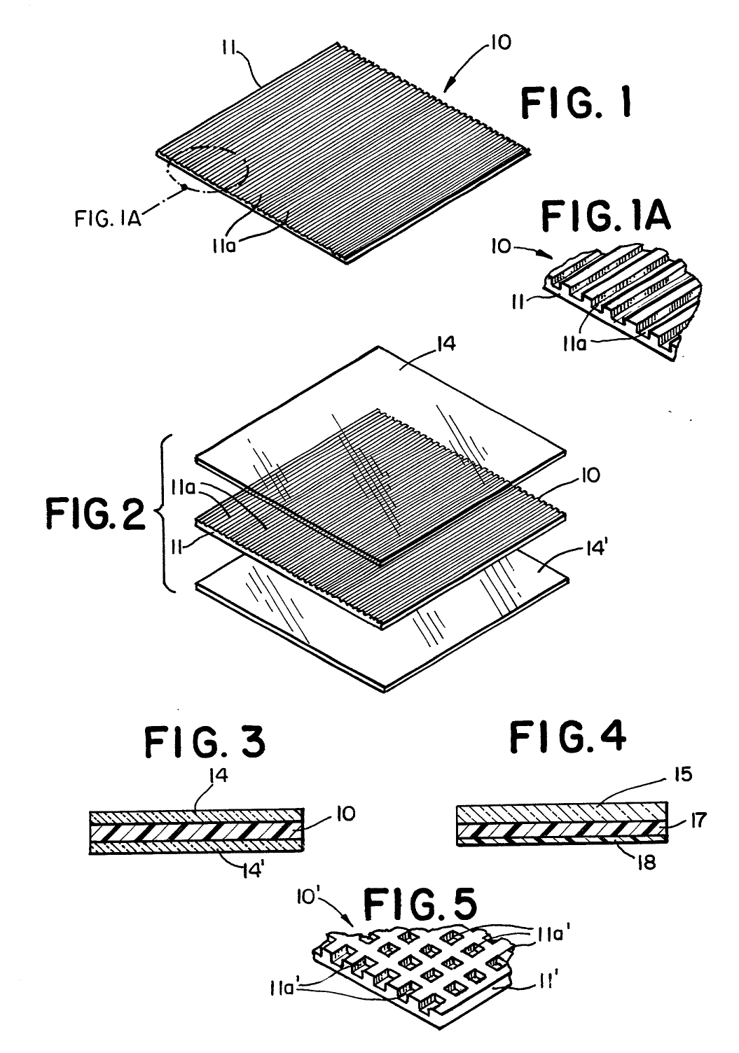

As illustrated in FIGS. 1 and 1A, a bonding layer 10, which is used as an interlayer between two optically clear sheets of glass, is provided with grooves 11 on at least one side. The grooved portions permit the escape of off-gases during the laminating process of the invention. The scores or grooves 11 are in the range of about 25 to 300 microinches deep and a maximum width of 300 microinches, preferably between 25-200 microinches. The direction of scoring is not critical, but should continue to the edge of the laminate to expel gases.

FIG. 2 illustrates an assembly 12 which may be used in the process of the invention. The assembly comprises a glass sheet 14 having a bonding layer 11 on its two surfaces (not shown), and a glass sheet 14 on the other surface.

FIG. 3 illustrates the assembly 12 after undergoing treatment under heat and pressure pursuant to the invention whereby a unitary resinous layer 11 is found free of any bubbles.

FIG. 4 illustrates another form of laminate 15, which may be prepared by the process of the invention wherein the bonding layer 16, which was embossed on one side, is bound to a transparent plastic sheet 17, which contains an optional hard coat 18 on its outside surface. When glass is used in lieu of the transparent plastic sheet, it is not necessary to apply a hard coat.

FIG. 5 illustrates a bonding layer which contains non-contiguous grooves whereby gas is trapped in pockets and causes haze and/or delamination.

According to the process of the invention, an extruded film comprising a copolymer of an olefin and from 13 to 21% by weight of a methacrylic or acrylic acid which has been neutralized 40 to 90% with an alkali metal cation and which has a Tg of less than 210° F. is used as the bonding layer.

The bonding layer, which is generally extruded to 4-60 mils in thickness, is cut into a desired form for example, 12 inch squares, or not cut and continuously passed through a scoring apparatus to groove at least one side. The bonding layer is preferably scored on the surface adjacent the glass layer or layers. The cut grooved sheets are then cleaned with isopropanol and stacked on a primed outer sheet or between two primed sheets of glass. The amount of sheets utilized depends on the types of glass desired. An overall thickness of about 30-60 mils is generally sufficient for security glass. The stacked assembly is subjected to heat and pressure sufficient to cause permanent adherence of one glass layer to another through the laminating resin layer. Desirably, the stacked assembly is passed through rollers to lightly adhere the layers together. Preferably the assembly is placed in a so-called “polymar” bag of the type disclosed in U.S. Pat. No. 3,311,517. The bag comprises an outer ply of polyethylene terephthalate and an inner layer of polyethylene. The bag is generally inserted into a second bag of the same material evacuated and sealed. The sealed bag is placed in an autoclave at a temperature of about 255-280° F. for about 3-20 minutes under about 20-200 psi pressure in a vacuum.

The assembly is then cooled to about 150° F. within about 30 to 45 minutes to avoid clouding and the pressure is reduced.

The thickness of the inner and outer layers in accordance with this invention can be selected to be variable depending on the purpose for which they are used. The number of individual layers of the composite article is likewise selectable as desired. This makes the article useful in the construction field in connection with doors and door systems, in windows and window constructions, in parapets for railings, balconies, or facades, in partitions as room dividers, balcony partitions, or lot enclosures, in connection with roofs or roof components of terraces, skylights, or greenhouses, in telephone booth or computer system enclosures, display cabinets, cashier's cages, prisons, or rooms endangered by explosion or implosion, in each case as safety glass for protection against penetration, break-in, shelling, fire, sound, cold, warmth, heat, optionally with alarm or heating wires, respectively.

The bonding layers are extruded copolymers comprising copolymers of olefins, preferably having ethylene groups, and 13 to 21% by weight of methacrylic or acrylic acid monomers which have been neutralized from 40 to 90% preferably with an alkali metal cation. The bonding layer has a Tg of less than 210° F.

The bonding film contains 0 to 5% by weight of a polyamine which has at least one R—CH₂—NH₂ group, and the R may contain: (CH₂NH₂)ₓ; and, (R′R″NH)_{y}, where x=1 or more, and y=0 or more. R′ and Rₓ″ may be any organic groups. The preferable structure of the diamine is:

NH₂CH₂—(R)—CH₂NH₂

Where R contains from one to 12 carbon atoms; R may be aliphatic or alicyclic; and R may also contain:

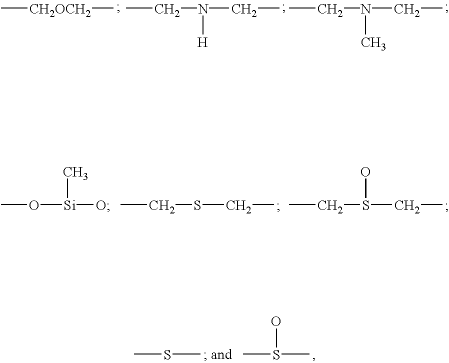

Examples of the preferred diamines which can be used are

1,12-diaminododecane;

2-methyl-1,5-pentanediamine;

1,6-diaminohexane;

Bis (1,3-aminomethy) cyclohexane (BAC); and

1,3-diaminomethylxylene.

In addition, the copolymer prior to the polyamine addition may already be partially neutralized from 40 to 90% with a metal cation such as sodium or other alkali metal salt.

Any of the usual types of glass used in so-called safety applications can be used in conjunction with the process of the present invention including chemically and thermally strengthened or tempered glass as well as common untempered glass where indicated. Amongst the glasses which may be used are silicate glass, E-glass, Toro® glass, etc. The type used depends upon the intended use of the laminate. The nature and composition of some of the various glasses is known in the art and described, for example, in the “Encyclopedia of Chemical Technology” by Kirk-Othmer, published by lnterscience Encyclopedia Inc. New York, N.Y., Vol. 7, pages 181-189, et seq., which is herewith incorporated by reference.

Primers, particularly suitable for glass, and the glass/copolymer interface include silanes such as those produced under the registered trademarks “Z-6040” and “Z-6020” by Dow Chemical Company may also be used.

There is a difference in the uses of scored or grooved bonding layers over embossed or knurled surfaces. Scoring indentations permits a flat bonding surface while embossing distorts the surface into raised portions which may create pockets with the glass covering.

The present invention is further illustrated by the following examples.

### EXAMPLE 1

A windshield or windscreen is prepared by stacking an extruded sheet of polyethylene/methacrylic acid neutralized with sodium cations, which has been scored on the surfaces on an outboard layer of 250 mils of chemically strengthened glass coated with Z-6040 primer of Dow Chemical Company. An inboard layer of 1.5 mils of chemically tempered glass, as disclosed in U.S. Pat. No. 3,395,998 and commercially available from PPG Glass Company of Pittsburg, Pa. Is used to complete the assembly. The assembly was placed in a vacuum bag and heated to 250° F. for 45 minutes in an autoclave. The pressure was released and the assembly cooled to about 150° F. in 30 minutes. The laminate can then be placed in a suitable glazing structure. The laminate was free of bubbles and optically clear.

### EXAMPLE 2

A diamine cross-linked partially (40%) neutralized with sodium cations ethylene-methacrylic acid copolymer was added to the resin port of a small extruder having an extruding barrel temperature which was maintained at 325°-400° F. A film (50 mils) was extruded, scored and cut into twelve-inch squares and then stacked between one-eighth inch sheets of tempered glass plates. The assembly was placed in a so-called “polymar” bag of the type disclosed in U.S. Pat. No. 3,311,517 to Keslar et al. The bag is comprised of polyethylene terephthalate. The bag was inserted into a second bag of the same material, evacuated and sealed. The sealed unit was placed in an autoclave at 280° F., for 2 hours under 20 psi pressure in a vacuum. The unit was then cooled to 150° C. in 30 minutes and the pressure reduced. The assembly was removed from the autoclave and the bags and plastic wrapping were removed from the assembly.

The resulting bubble-free laminate is then ready to insert into a suitable support or frame and secured therein.

The form of the invention shown and described herein represents an illustrative preferred embodiment and variations thereof. It is understood that various changes may be made without departing from the gist of the invention as defined in the claims.

What is claimed is:

1. A method for preparing a transparent laminated article comprising an extruded bonding film and at least one transparent sheet of glass which comprises the steps of;
A. providing a multiplicity of contiguous grooves on at least one surface of a bonding film, said bonding film comprising a copolymer of an olefin and 13 to 21% by weight of methacrylic or acrylic acid monomers partially neutralized with an alkali cation and the indentations or grooves of the scored surface being about 25 to 300 microinches deep and 20-300 microinches wide;
B. placing a sheet of glass in contact with the grooved surface of said bonding film to form an assembly and then;
C. applying heat and pressure or vacuum to the assembly to form a laminate.

2. The method of claim 1 wherein said bonding film and sheet are heated under a pressure of about 20 to 200 psi.

3. The method of claim 2 wherein said bonding film and sheet are heated to a temperature of about 255-280° F.

4. The method of claim 3 wherein the temperature is reduced to about 150° F. within about 30 to 45 minutes.

5. The method of claim 1 wherein said bonding film comprises a copolymer of ethylene and methacrylic or acrylic acid monomers at least partially neutralized with an alkali cation.

6. The method of claim 5 wherein said bonding film is the partially neutralized acid form of an ethylene-methacrylic acid copolymer.

7. The method of claim 1 wherein said bonding film is sandwiched between two sheets of glass.

8. The method of claim 1 wherein said bonding film is scored on both sides.

9. The method of claim 1 wherein said bonding layer has a glass transition temperature of less than 210° F.

10. An extruded film which comprises a copolymer of:
A. ethylene, and
B. 13 to 21% by weight of methacrylic or acrylic acid monomers which have been neutralized 40 to 90% with an alkali metal cation, said film having a glass transition temperature of less than 210° F.

11. The film of claim 10 wherein said bonding film is a neutralized diamine cross-linked copolymer prepared from polyethylene and methacrylic or acrylic acid monomers.

12. The film of claim 10 wherein said bonding film is grooved on both sides, said grooves being contiguous and having a maximum depth and width of about 300 microinches.

13. A transparent laminate prepared by the method of claim 1.

14. A transparent laminate prepared by the method of claim 5.

15. A transparent laminate prepared by the method of claim 7.

16. A transparent laminate prepared by the method of claim 9.
